(19) United States
(12) Patent Application Publication
(10) Pub. No.: US 2009/0174118 A1
(43) Pub. Date: Jul. 9, 2009

(54) Method and device for nano-imprinting

(76) Inventors: Ryutaro Maeda, Ibaraki (JP); Harutaka Mekaru, Ibaraki (JP); Hiroshi Goto, Ibaraki (JP)

Correspondence Address: HARRINGTON & SMITH, PC, 4 RESEARCH DRIVE, Suite 202, SHELTON, CT, 06484-6212, US

(21) Appl. No.: 11/921,700

(22) PCT Filed: May 31, 2006
(86) PCT No.: PCT/JP2006/310892

§ 371 Date: Feb. 13, 2009

(30) Foreign Application Priority Data
Jun. 10, 2005 (JP) 2005-170301
Dec. 27, 2005 (JP) 2005-375998

(51) Int. Cl. B29C 43/58; B29C 59/02; B29C 47/78; B29C 43/50

(52) U.S. Cl. 264/323; 425/112; 425/149; 425/441; 977/887

(57) ABSTRACT

A nanoimprint system according to one embodiment of the present invention is a system for performing a pattern transfer onto an object to be molded by pressing a mold against the object to be molded using a head, characterized in that the head has a flat pressing surface during pressing the mold and is slid onto the mold while pressing the mold.

### TECHNICAL FIELD

The present invention relates to nanoimprint technology, more specifically to a technology that may be employed for improving the nanoimprint process.

### BACKGROUND ART

In recent years, nanoimprint technology has been receiving a lot of attention as a manufacturing process of ultra-fine three-dimensional nanostructures. A thermal nanoimprint process, which is one nanoimprint technology, involves heating/pressing a high precision processing form (a mold) onto a workpiece material (resin and glass), and then transferring the mold pattern onto the workpiece material. A process chart of the thermal nanoimprint process is shown in FIG. 1. This is a technology which is capable of forming a nanostructure under the very simple processes of simply heating and pressing a mold against a material.

A nanoimprint process, which has been receiving attention as a promising technology for forming a 32 nm or less extra-fine line pattern in LSI lithography, has been expected to be widely developed for applications other than LSI, and has already started being applied to light-emitting devices used for display units (light guide plates and microlens arrays). Additionally, practical applications are also rapidly being considered for patterned media, such as next-generation DVDs and high-density magnetic recording discs. However, under current circumstances, the nanoimprint process is at a level in which a foundational process technology has been established, but there remain some important issues for practical applications, and so the application range thereof is limited under actual situations.

One of the issues is improving the process throughput. A nanoimprint, which is one type of molding fabrication technology, can demonstrate its value only if it manufactures devices in large quantities and at low cost. Therefore, it is essential to improve the process throughput (time required for manufacturing a device), which is the most important issue. At present, one process (molding fabrication process) requires a few minutes even at shortest, but generally several tens of minutes, making it difficult to state that this process is excellent in mass productivity, and thus, it is necessary to work on shortening this time.

Another issue is responding to a large area. One method for improving productivity is to simultaneously manufacture a plurality of devices in a large area. Japanese Unexamined Patent Application Publication No. 2004-288811 has already disclosed an apparatus that is capable of simultaneously molding the entire area of a wafer, which has been promoting the response to such a large area. However, it is assumed that this simultaneous method causes many problems, such as increased press loads (several tens of tons), temperature uniformity, applied compression uniformity, and flatness management for a molding surface, in accordance with the increased area.

Furthermore, Professor Chou at Princeton University, et al., have researched a continuous transferring nanoimprint system that uses rollers (Hua Tan, Andrew Gibertson, Stephen Y Chou, “Roller nanoimprint lithography” J. Vac. Sci. Technol. B16 (6), 3926 (1998)). However, in this paper, only 10 mm of molding fabrication is achieved for one minute, resulting in a moldability that is far from any practical application.

In upcoming years, the nanoimprint process is highly expected to be applied to display units (a filter structure, an antireflection coating, a back light leading plate, etc.), and under the assumption of these applications, it is necessary to consider a nanoimprint process which is capable of being applied to large substrates of 40 inches and 50 inches in size, in accordance with an increased screen size (flat-screen display units, such as liquid crystal and plasma).

Considering the above circumstances, it is necessary to develop a new process other than a simultaneous imprinting system, which enables a substrate as large as 1 m, based on the current nanoimprint process in which substrates of 200-300 mm in size are mainly used.

### DISCLOSURE OF THE INVENTION

The present invention has been developed to establish a process technology which simultaneously satisfies an improvement in process throughput and an adaptation to a large area nanoinpring in a thermal nanoimprint process.

The present invention includes the following nanoimprint system in one embodiment thereof. This nanoimprint system is characterized in that it performs a pattern transfer onto an object to be molded by pressing a mold against the object to be molded using a head, and is arranged that the head has a flat pressing surface during pressing the mold and is slid onto the mold while pressing the mold.

In the abovementioned nanoimprint system, the nanoimprint head has a flat pressing surface at the time of pressing the mold, which makes it possible to ensure sufficient time for pressing the mold even if the head is moved on the mold. Thus, in the abovementioned nanoimprint system, even if the sliding speed between the head and the mold is accelerated, resin can be heated/pressed sufficiently long enough for the resin to be deformed, making it possible to more substantially improve the process throughput compared to the abovementioned system proposed by Professor Chou. Additionally, in the abovementioned nanoimprint system, since the area to be pressed at one time is small, it is easier to control the temperature uniformity, applied compression uniformity, and flatness management of a pressing surface, especially in the case of performing a large area nanoimprint, compared with the simultaneous pressing method disclosed in Japanese Unexamined Patent Application Publication No. 2004-288811. Furthermore, the abovementioned nanoimprint system can be easily applied to a large area substrate and mold by expanding the operating range of the mechanism for sliding the head on the mold. Thus, the abovementioned nanoimprint system has a highly excellent property as a nanoimprint apparatus applicable to a large substrate.

In the abovementioned nanoimprint system, the mechanism for sliding the head on the mold may be configured so that the head is movable relative to the mold or, in contrast, so that the mold is movable relative to the head.

In the abovementioned nanoimprint system, it is preferable that a heater be installed within the head such that the heater is biased in the head to the sliding direction of the head. Such an arrangement results in a high-speed molding process because the heater is not applied on the molded part at the end of pressing phase and, thus, the temperature of the molded part can be decreased while the press is still being continued. It is also preferable to arrange that the part of the mold where the pattern transfer has been completed is sequentially released from the mold while the head and the mold are slid. Such a configuration results in an easier mold release especially when releasing a large area mold, compared to the case in which the entire mold is released from the molded object all at once. It is also preferable to arrange to apply fine vibration to the mold at the time of releasing the mold from the molded object. Ultrasonic waves may be used as a means for applying fine vibration. It is preferable to arrange that the effective width of the head is approximately the same as the width of the nanoimprint.

When the abovementioned head presses the mold, the pressing surface of the head may be completely flat, gently curved, somewhat concavo-convex, or wave-shaped. In one embodiment, the head may be arranged to make the pressing surface substantially flat by lining up multiple rollers on the pressing surface of the head. In still another embodiment, the head comprises an endless track structure for facilitating sliding, and an track shoe of the endless track structure can form the pressing surface. In still yet another embodiment, the head has no flat part under the condition in which pressing is not performed, but the contact part between the head and the mold is arranged to be deformed so that it forms a flat pressing surface at the time of pressing. In summary, it is important to form the pressing surface of the head as a structure in which the pressing surface is substantially flat when the head presses the mold, and can presses a reasonable size of areas simultaneously.

In one embodiment, a relaxation part can be provided at the edge of the pressing surface of the head in the sliding direction to relieve the pressing force applied to the molded object. For example, the relaxation part may be formed by making the pressing surface curved and angled in a direction away from the contact surface between the pressing surface and the mold. In the case of using the pressing surface lined up with multiple rollers as described above, the relaxation part can be provided by reducing the diameter of the rollers. The benefits for providing the relaxation part are as follows. The part of the workpiece substrate immediately after the head starts pressing is not yet heated sufficiently by the heater and, thus, does not have sufficient flexibility, making it difficult to be deformed even it is pressed by the mold. As a result, it is difficult for the workpiece substrate to be deformed if this part is pressed with the same pressure as other flexible parts that have been sufficiently heated, and in fact, there is a possibility that the mold will be damaged. Therefore, by providing a structure for relieving the pressing force at the edge of the moving direction, it is possible to make the workpiece substrate sufficiently heated and flexible before applying the maximum pressing power.

When the mold pattern is transferred onto the object to be molded, the condition of the press varies significantly depending on the pattern forms to be transferred. For example, pressing energies necessary to be molded (force×pressing time) are different between a part densely placed with fine patterns and a part roughly placed with large patterns. Thus, in the preferred embodiment, the abovementioned nanoimprint apparatus is preferably arranged that the relative speed between the head and the mold is variable depending on the position of the mold. It is also preferable to be arranged that the pressing force of the head is variable depending on the position of the mold. The relative speed and pressing force may be adjusted according to the pattern shape, which enables the pattern transfer to be reliably performed in addition to the throughput being improved.

In one embodiment, the present invention includes a nanoimprint method for performing a pattern transfer onto an object to be molded by pressing a mold against the object to be molded using a head, characterized by pressing the mold using a head while the head is slid onto the mold, where the head having a substantially flat pressing surface.

In one embodiment, the present invention includes a nanoimprint method or system for transferring a fine pattern formed on a mold onto an object to be molded by pressing the mold onto the object to be molded, characterized by performing a press onto the object to be molded of the mold using a head having a smaller pressing area than the mold, gradually moving the part of the mold pressed by the head and releasing the part of the mold where the press of the head has been completed in accordance with the move of the mold.

Especially in a thermal nanoimprint, if the mold release is performed after the molded body is cooled, there has been a problem in that mold release is difficult because the molded body is firmly attached with the mold due to heat contraction and thus, mold release requires a large force. There has also been a problem in that the transferred pattern is broken at the time of mold releasing by forcibly releasing the mold and the molded object, which are fixedly connected. The larger the nanoimprint area is, the more significant these problems are, and therefore, these problems should be solved in order to handle large areas. According to the abovementioned nanoimprint method and system, by using a head having a smaller pressing area than the molded range for pressing the mold onto the object to be molded gradually moving the part of the mold pressed by the head, and releasing the part of the mold that has been completed by pressing with the head, it is possible to release the mold before the effect of heat contraction of the molded object is significant, and thus the mold can be smoothly released from the molded object. It is also possible to minimize the occurrence of the problem of the pattern being broken at the time of mold releasing. Additionally, pattern transfer and mold release are nearly simultaneously performed, possibly contributing to an improvement in process throughput. The time taken between releasing the head and performing mold release should be adjusted so that the pattern transferred onto the molded body can be firmed, but preferably adjusted so that it is demolded as soon as possible after the transferred pattern is firmed.

The abovementioned nanoimprint method and system preferably optimizes the parameters for the relative moving speed between the mold and the object to be molded, the pressing load, and the temperature of the heater by sufficiently recognizing the viscoelastic properties and molding form for the resin of the workpiece material. The molding time can be substantially reduced by optimizing theses parameters. These parameters are preferably arranged to be variably controlled during nanoimprinting. Pressing may be performed not once but two or more times. For example, after performing pressing by moving the mold and the workpiece material in one direction relative to the head, pressing may be performed again by reversing the moving direction. If the press is performed twice for the same part by reversing the moving direction, it may be possible to solve an unclearness of the transfer pattern caused by the moving direction, and realize to transfer a clearer pattern.

In the abovementioned nanoimprint method and system, high pressure can be easily obtained even for a low-powered pressurizer by not pressing the entire mold at once but pressing a small area at a time using a head shaped with a linear or elongated form. For example, in the case of performing a nanoimprint in a simultaneous imprinting system on a 10 cm×10 cm area, it depends on the material quality of the molded body, but the necessary loads will reach as large as 5 tons. However, if a head shaped with a linear or elongated form, such as a roller-type head, is used for reducing the pressing area, the nanoimprint can be performed for the same area with a few hundred kilograms. This leads to reduce the size of the pressurizer, and contributes to the size reduction and price reduction of the system. Additionally, it makes possible to employ an electric motor as a source of power which is not possible to use it for a conventional nanoimprint of a large area simultaneous imprint because of its low power, even though it is capable of controlling the detailed load simultaneous.

Additionally, if a roller-type head is used as a pressing head, a relative motion of the mold relative to the head can be smoothly performed. The motion can be made smoother by configuring so as to rotate the roller head in accordance to the abovementioned relative motion by using a motor, etc.

In one embodiment, the abovementioned nanoimprint system according to the present invention includes the following system. This system is a nanoimprint apparatus for transferring a fine pattern formed on a mold onto an object to be molded by pressing the mold onto the object to be molded by using a pressing head, where said apparatus carrying out a nanoimprint for an entire area to be molded by performing the press by using a head having a smaller pressing area than the area to be molded and by gradually changing the positions to be pressed, where said system further comprises:
a jig for securing the area to be molded of the object to be molded,
a mold elevator arranged to secure the mold at one side and the other side thereof by a mold securing member, and to be capable of independently elevating the one side and the other side of the mold,
a stage for moving the jig for securing the object to be molded and the mold elevator relative to the head during nanoimprinting, and
a controller for controlling elevation of the mold elevator and motion of the stage, where the mold elevator and the stage are controlled to lift or lower one of the one side and the other side of the mold in accordance with the motion of the stage in order to release a part of the mold where the press of the mold has been finished from the object to be molded, during the nanoimprinting.

The controller is preferably arranged to variably control the moving speed of the stage during nanoimprinting. The pressing force applied by the head may also be arranged to be controlled by the controller, and the controller is preferably capable of variably controlling the pressing force in accordance with the motion of the stage. Additionally, a heater, the temperature of which is controlled by the controller, is provided with one or more of the head, the jig for securing the object to be molded, and the stage, and the controller is preferably arranged to control the temperature of the heater in accordance with the motion of the stage.

The mold securing member comprises a mold securing jig for securing the mold, an elastic member for connecting the mold securing jig, and a body of the mold elevator. The variation of forces applied at the time of mold releasing can be absorbed into the elastic member by interposing the elastic member between the body of the mold elevator and the mold. The elastic member is preferably removable, and such configuration enables different elastic members to be easily replaced if necessary depending on the type and form of the object to be molded/the property of the mold. Additionally, it is preferably arranged to provide a plurality of connection units for connecting the elastic members respectively to the mold securing jig and the body of the mold elevator so that the number of elastic members can be adjusted depending on the necessary elastic force.

For the case in which the object to be molded is larger than the jig for securing the object to be molded, for example, in the case of a continuous film shape, the abovementioned nanoimprint system preferably comprises a guide which holds said object to be molded, where said object to be molded and is capable of moving said object to be molded in accordance with the motion of the stage and independent of the motion of the stage.

And the controller may be arranged to feed, by the guide, next portion of the object to be molded onto said jig for securing the object to be molded after completing a nanoimprint of a portion currently secured to the jig for securing the object to be molded, then to secure said next portion to the jig for securing the object to be molded, and subsequently to perform a nanoimprint for said next portion. This arrangement makes it possible to mold a large-sized substrate and continuous shaped substrate which cannot be imprinted with a single attempt.

The present invention improves the process throughput in addition to providing a thermal nanoimprint technique that can respond to a large area.

### DETAILED DESCRIPTION OF THE PREFERRED EMBODIMENTS

Preferred embodiments of the present invention will be described below with reference to attached drawings.

FIG. 2 is a conceptual diagram of a nanoimprint apparatus 100 according to the present invention. The nanoimprint apparatus 100 comprises a stage 104 for securing a workpiece substrate 102, a mold holding unit 108a, 108b, 109a, and 109b for securing a mold 106, a mold elevating mechanism 110 for elevating the mold 106 together with the mold holding units 108 and 109 and a head 112 for pressing the mold 106 against the workpiece material 102.

The nanoimprint apparatus 100 is capable of performing a nanoimprint on a large area by novel features provided by the present invention. In this embodiment, the nanoimprint molding area for the workpiece substrate 102 is 300×500 mm. Therefore, a large area plate mold is also used for the mold 106. Since the thickness of the mold 106 is preferably thin, considering easy mold release, the thinness of the mold is to be 200-300 μm. A mold used for a nanoimprint is manufactured by firstly forming a pattern on a silicon substrate generally by using a semiconductor exposure apparatus and electron beam lithography, etching it and then making an original known as a master, and further completing it into a mold loaded with three-dimensional nanostructure by electroformed nickel. However, a master which is directly manufactured by a semiconductor exposure apparatus and electron beam lithography is one which can correspond to a 300-mm wafer at the largest. Larger sized molds are manufactured by a step-and-repeat method, which repeatedly transfers patterns on a substrate by using a mold of a few 10 mm.

With respect to the material for the workpiece substrate 102, a resin material with a molding temperature of 200° C. or less is preferred, considering the durability and heat resistance properties of the Ni electroforming type used for the mold 106. Examples of such resin materials include a PMMA resin used for a resist, and a polycarbonate resin and a COP resin (for example, Zeonex resin manufactured by ZEON CORPORATION) used for an optical device, all of which can be molded at a temperature of 200° C. or less.

The stage 104 secures the workpiece substrate 102 with a vacuum contact or a mechanical clamp. The stage 104 also comprises a heater 114, which enables the workpiece substrate 102 to be heated under a glass transition temperature (Tg). The stage 104 is arranged to be capable of moving in the left direction 120 horizontally relative to the apparatus body 100, while securing the workpiece substrate 102.

The mold holding units 108 and 109 sandwich and secure the mold 106. The mold holding units 108 and 109 are secured under the condition in which they can elevate on the mold elevating mechanism 110, which enables the mold 106 to be contacted with and released from the workpiece substrate 102. The mold holding units 108 and 109 also comprise a fine vibration-assisting function, which enables easy mold release by applying a high-frequency fine vibration to the mold 106 at the time of mold releasing. Ultrasonic waves may be used for assisting the fine vibration. The mold elevating mechanism 110 can independently elevate the mold holding units 108 and 109, thus enabling operation, such as by only one side of the mold 106 being able to be released from the workpiece substrate 102. The mold elevating mechanism 110 is secured to the stage 104, and therefore, when the stage 104 is moved, the molding elevating mechanism 110 along with the mold holding units 108 and 109 secured by the mold elevating mechanism 110 are accordingly moved at the same speed. Therefore, when the stage 104 is moved, the workpiece substrate 102 and the mold 106 can be moved at the same speed relative to the head 112.

The head 112 made of heat-resisting metal contacts the mold 106 at the time of nanoimprinting, and presses the mold 106 against the workpiece substrate 102 with the given loads. The head 112 may be arranged to directly contact the mold 106, but may also be arranged to convey the pressing forces to the mold 106 via some different material. A surface that presses the mold 106 is formed in the plane, enabling a certain sized area to be pressed at one time. In other words, the head 112 performs pressing at the surface contact with the mold 106. In this embodiment, a valid size for the head 112 is to be 300 mm×20 mm so that the nanoimprint molding width can be pressed at one time. In other embodiments, the pressing surface of the head 112 can be formed in the plane with some concavities/convexities, be in corrugated form, or be incorporated with multiple rollers. Consequently, it is important to form the pressing surface of the head 112 in the flat plane so as to press a certain area at one time.

The horizontal position of the head 112 is secured relative to the apparatus body 100, but is arranged to be capable of moving upwards and downwards vertically. Additionally, the head 112 is arranged to press the mold 106 with the load F applied by a pressing mechanism not shown in the figure, when performing a nanoimprint. The magnitude of the load F should be adjusted accordingly depending on the nature of the workpiece substrate. The head 112 internally comprises a heater 116, which enables the mold 106 to be heated to Tg or more. The optimal heating temperature should be defined accordingly depending on the nature of the workpiece substrate, but in general, a temperature of approximately Tg+10% is appropriate. The heater 116 is installed within the head 112 in a position biased to the relative moving direction of the head 112. As shown in FIG. 2, the heater 116 is installed in the head 112 in a position biased to the right direction of the figure.

When performing a nanoimprint, the stage 104 is slowly moved horizontally 120, and in accordance with this motion, the mold elevating mechanism 110 as well as the mold holding units 108 and 109 are also moved in the same direction and at the same speed. However, the head 112 is secured, and therefore the head 112 is slid onto the mold 106 in accordance with the motions of the stage 104 and the mold holding units 108 and 109. In other words, when performing a nanoimprint, the head 112 is slid onto the mold 106 by pressing the mold 106 with the load F applied by a pressing mechanism not shown in the figure, thus performing pressing on the entire of the nanoimprint area. This process is similar to ironing. Refer to FIG. 3. Additionally, it is found that the heater 116 is installed biased to the sliding direction of the head 112. It is preferable to use lubricant between the head 112 and mold 106 in order to facilitate sliding of the head 112.

The operation of the nanoimprint apparatus 100 will be described with reference to FIG. 3. FIG. 3 (a) is under the condition in which the workpiece substrate 102 and the mold 106 are set in the nanoimprint apparatus 100. The workpiece substrate 102 and mold 106 are not yet in contact with each other. Once the condition of FIG. 3 (a) is shifted to the condition of FIG. 3 (b), the mold elevating mechanism 110 lowers the mold holding units 108 and 109 and brings the mold 106 into contact with the workpiece substrate 102. The pressing mechanism, not shown in the figure, causes the head 112 to press the mold 106 with the load F. Additionally, the heater 114 heats the workpiece substrate 102 up to a temperature of Tg or less, while the heather 116 heats the mold 106 up to a temperature of Tg or more.

In the next stage, the stage 104 is slowly moved in the left direction of the figure, while securing to the workpiece substrate 102. Subsequently, since the mold holding units 108 and 109 are also secured to the stage 104 via the mold elevating mechanism 110, the mold holding units 108 and 109 are also moved in the same direction and at the same speed as the stage 104, while securing to the mold 106. Thus, the head 112 is slid onto the mold 106, while pressing the mold 106 with the load F. This process is shown from FIG. 3 (b) to FIG. 3 (e). The moving speed of the stage 104 is adjusted according to the property of the workpiece substrate 102, so that a part of the workpiece substrate 102, which is pressed by the head 112, can be heated/pressed sufficiently long enough to be deformed. The pressing surface of the head 112 is formed on the flat plane, which enables the pressing time for one part to be increased, thus making it possible for the relative speed between the head 112 and the mold 106 to be faster than the system proposed by the abovementioned Professor Chou.

As shown in FIG. 3 (b)-(e), the installation position of the heater 116 is biased in the moving direction of the head 112 relative to the mold 106. Accordingly, in accordance with the sliding of the head 112, a part of the workpiece substrate to be newly pressed can first be sufficiently heated by the heater 116. Once the head 112 is slid more, the relevant part is not applied with heat and therefore the relevant part can be slowly cooled for the preparation of the mold release, while remaining pressed by the head 112. Thus, when the head 112 is slid more and the head 112 is not applied to the relevant part, the relevant part is transferred with a pattern as well as being cooled down to an appropriate temperature at which mold release can be performed. As described above, the nanoimprint apparatus 100 is capable of performing a pattern transfer with high efficiency.

Furthermore, the mold elevating mechanism 110 sequentially releases the mold 106 by elevating the mold holding unit 108 from the part at which the pattern transfer has been completed by the head 112. This procedure is shown from FIG. 3 (c) to (e). In this way, the mold is gradually demolded from the workpiece substrate, and thereby, mold release can be performed comparatively easily even for large area molds (the larger the area is, the more difficult it is to release a large area mold all at once). The mold 106 has a thickness of approximately 200-300 μm as described above, and is flexible enough to be bent between the mold holding unit 108 and the head 112. The mold holding unit 108 applies high-frequency fine vibrations to the mold 106 at the time of mold releasing in order to facilitate the mold release.

As described above, the larger the area is, the more difficult it is to release a large area mold all at once. Therefore, features of the nanoimprint apparatus 100 including using a flexible and thin mold for pattern transfer, and releasing the mold from an object to be molded as if the mold was turned over, are highly useful in making mold release easy in a nanoimprint process using a large area mold.

Once the head 112 is slid onto the entire molded area and completes the press on the entire molded area, the stage 104 stops moving (FIG. 3(e)). The heater 114 and 116 also stop heating. Then the head 112 and the mold holding unit 109 are elevated to completely release the mold 106 from the workpiece substrate 102 (FIG. 3(f).

As described above, in the nanoimprint apparatus 100, the pressing surface of the head 112 is formed in the flat plane, and thereby, sufficient heating/pressing for the resin to be deformed can be ensured even if the sliding speed between the head and mold is accelerated, making it possible to more substantially improve the process throughput, compared to the system proposed by Professor Chou. Additionally, the heater 116 is installed biased to one side within the nanoimprint head 112, and thereby the processes of heating, pressing, and cooling can be performed with high efficiency, and additionally, the mold release is sequentially performed from the part where the pattern transfer has been completed, which also leads to a easy/high-speed mold releasing process. This feature also substantially contributes to an improvement in the process throughput performed by the nanoimprint apparatus 100.

In the case of performing a large area nanoimprint, since the area to be pressed at one time is smaller for the nanoimprint apparatus 100, it is easier to control temperature uniformity, applied compression uniformity, and flatness management of the pressing surface, compared with the simultaneous pressing method disclosed in Japanese Unexamined Patent Application Publication No. 2004-288811. Thus, the nanoimprint apparatus 100 has a highly excellent property as a nanoimprint apparatus that is applicable to a large-sized substrate. In this embodiment, the nanoimprint molding area for the workpiece substrate 102 is set as 300×500 mm, but the nanoimprint technology described herein could be applied to a workpiece substrate of a unit as large as meters. Thus, the nanoimprint process in which the nanoimprint apparatus 100 is applied, can be developed to many applications, and therefore, the way of applying the nanoimprint process will be open to low-cost nanofabrication technologies such as a back light leading plate, an antireflection coating, a microlens array, light-emitting devices, bioelectronics devices, and patterned media, which are incorporated in liquid crystal displays (A4 and A3 size) for laptop PCs.

When the mold pattern is transferred onto the object to be molded, the condition of the press substantially varies depending on the pattern forms to be transferred. For example, the pressing energies necessary to be molded (force×pressing time) are different between a part densely placed with fine patterns and a part roughly placed with large patterns. Thus, the nanoimprint apparatus 100 is preferably arranged that the moving speed of the stage 104 is variable depending on the positional relation between the mold 106 and the head 112. Such configuration enables pattern transfer to be reliably performed by slowing the moving speed of the stage 104 for parts densely placed with fine patterns, in addition to enabling the transfer process to be completed faster by accelerating the moving speed of the stage 104 for parts roughly placed with large patterns. Additionally, the pressing force applied from the head 112 to the mold 106 is also preferably arranged to be variable depending on the position of the mold. Such configuration enables the pressing force to be stronger for parts densely placed with fine patterns, and thereby, the nanoimprint can be continuously performed without substantially slowing the moving speed of the stage 104, which contributes to an improvement in the throughput. The adjustment of the pressing force for the head pressing mechanism as well as the adjustment of the speed for the stage moving mechanism can be controlled by computer.

Embodiments of a nanoimprint head used for a nanoimprint system according to the present invention can take various shapes. FIG. 4 shows another embodiment of a nanoimprint head according to the present invention. FIG. 4 (a) shows a nanoimprint head, which has a structure with lined-up multiple rollers on a pressing surface, making the pressing surface 202 a flat plane as a whole. The head shown in FIG. 4 (a) has a lesser degree of flatness compared with the head 112, but the pressing surface 202 and the mold are still in contact with each other and it is beneficial in that the rollers facilitate sliding between the head and the mold. In still another embodiment, a band-like structure may be wound around the rollers shown in FIG. 4 (a) to form an endless track structure with the rollers and the band-like structure. In this case, the endless track structure forms the pressing surface. FIG. 4 (b) is an embodiment in which the head is formed in a flat rolled shape. This embodiment also realizes a flat pressing surface 204.

FIG. 5 shows another embodiment of a nanoimprint head according to the present invention. FIG. 5 (a) is a side view of a nanoimprint head 300 according to this new embodiment. The nanoimprint head 300 comprises a cylindrical metal core 302 embedded with a heater and a surface layer 304 made of rubber-like substances. Since the surface layer 304 is made of rubber-like substances, when the nanoimprint head 300 is pressed against the mold, the contact part between the surface layer 304 and the mold is deformed by the pressure, resulting in a flat pressing surface being realized. This procedure is shown in FIG. 5 (b). FIG. 5 (b) is a side view of the nanoimprint head 300, showing the procedure of the nanoimprint head 300 at the time of nanoimprinting. The nanoimprint head 300 is pressed against the mold 310 by a pressing mechanism, not shown in the figure, with the load F. Subsequently, the contact part between the surface layer 304 and the mold 310 is deformed by the pressure, which realizes a flat pressing surface 308. Once the mold 310 is moved horizontally in the left direction 320, the head 300 is rotated in the direction 322, and as a result, sliding between the head and the mold can be performed smoothly.

FIG. 6 shows still another embodiment of a nanoimprint head according to the present invention. FIG. 6 (a) is a side view of the nanoimprint head 400 according to this new embodiment. The nanoimprint head 400 comprises a cylindrical meal core 402 embedded with a heater and a surface layer 404 made of a thin metallic foil, as well as a structure filled with oil 406 between the core 402 and the surface layer 404. Once the nanoimprint head 400 is pressed against the mold, the oil 406 is moved by the pressure applied to the contact part between the surface layer 404 and the mold, which can result in the surface 404 being deformed and, thus, a flat pressing surface can be realized. This procedure is shown in FIG. 6 (b). FIG. 6 (b) is a side view of the nanoimprinting head 400, showing the procedure of the nanoimprint head 400 at the time of nanoimprinting. The nanoimprint head 400 is pressed against the mold 410 by a pressing mechanism, not shown in the figure, with the load F. Subsequently, the oil 406 is moved by the pressure applied to the contact part between the surface layer 404 and the mold 310, resulting in the surface layer of the contact part becoming flat as shown by the arrow 408. Once the mold 410 is moved horizontally in the left direction 420, the head 400 is rotated in the direction 422, and as a result, sliding between the head and the mold can be performed smoothly.

FIG. 7 shows still another embodiment of a nanoimprint head according to the present invention. FIG. 7 (a) is a side view of the nanoimprint head 500 according to this new embodiment. The nanoimprint head 500 has a pressing surface, an edge of which is curved in the direction away from the contact surface between the pressing surface and the mold. Other than this feature, this head is the same as the nanoimprint head 112 used for the first embodiment, has a flat pressing surface 501, and is installed with a heater 502 in the direction biased to the sliding direction.

Since the part of the workpiece substrate immediately after the head starts pressing is not yet sufficiently heated by the heater, it is difficult to be deformed even though the mold is pressed. Thus, it is difficult for the workpiece substrate to be deformed if pressed with the same pressure as other parts that have been sufficiently heated, and in fact, there is a possibility that the mold will be damaged. Therefore, the nanoimprint head 500 is provided with a relaxation part 504 for relieving the pressing force applied to the workpiece substrate by curving the edge of the pressing surface as shown in FIG. 5 (a). The relaxation part may be formed as a plane 504′ as shown in FIG. 5 (b) without curving. It should be noted that the degree of the curve of the relaxation part 504 and the angle of the relaxation part 504′ are emphasized for the purpose of the explanation, and therefore the actual degree and angle of the curve may be much smaller.

A nanoimprint operation using the nanoimprint head 500 will be described below with reference to FIG. 8. FIG. 8 shows a procedure in which the mold 510 is pressed against the workpiece substrate 512 by the nanoimprint head 500. The mold 510 and the workpiece substrate 512 are moved slowly on the left side of the figure by a moving mechanism, not shown in the figure, in the same way as the embodiment in FIG. 3, and the head 500 presses the mold by the load F with its horizontal position fixed.

FIG. 8 (a) depicts a stage in which a part of the workpiece substrate 512, which corresponds to position A, starts being pressed against the mold 510 by the head 500, in accordance with the sliding of the head 500. However, the load, which is applied by the head 500 and reaches position A, is smaller compared with other pressed positions, because the relaxation part 504 is curved in the direction away from the contact surface between the pressing surface and the mold. However, position A of the substrate will be heated by the heater 502 and be gradually increased with the flexibility. When the head 500 is slid more and position A is pressed by the flat plane 501, position A of the substrate is sufficiently heated and flexible enough to be transferred with a pattern (refer to FIG. 8 (b)). When the head 500 is slid more, position A of the substrate remains pressed against the mold 510 strongly by the flat plane 501, while position A is not applied with the heater 502 and thus, the temperature is gradually lowered (FIG. 8 (c)). If the temperature is sufficiently decreased, the pattern of the substrate will be firmed and thus allowed to be mold released. Meanwhile, the relaxation part 504 is depicted as not completely in contact with the mold 510 in FIG. 8 (a)-(c), but this is depicted so as to clarify that the relaxation part 504 has a curving structure, so an actual relaxation part 504 can also be configured to be in contact with the mold 510.

FIG. 9 is an external view of a nanoimprint apparatus 600 according to another embodiment of the present invention. The nanoimprint apparatus 600 is a nanoimprint apparatus for performing a pattern transfer by pressing a mold 619 against a workpiece substrate 660 (refer to FIG. 11) by a roller-type head 609. The pressing surface of the roller head 609 presents a linear or curved elongated rectangle form, and thus the area that can be pressed at one time is very small. Therefore, the nanoimprint apparatus 600 is arranged to perform a pattern transfer on the entire molded area by moving the mold 619 and the workpiece substrate 660 relative to the head 609 using the stage 602 and then changing the parts that are pressed by the head, while being pressed by the roller head 609, and finally performing a press on all parts of the molded area on the workpiece substrate 660.

The nanoimprint apparatus 600 comprises a stage 602 and roller head poles 605 on a base plate 601. A device group 621-633 for holding a mold 619 and a device group 635-639 for holding a workpiece substrate 660 are installed on the stage 602. The stage 602 can be moved on the base plate 601 by a stepping motor 603 that is installed under the base plate 601, horizontally 604a and in the direction 604b horizontally opposite relative to the direction 604a.

The roller head pole 605 is secured by the base plate 601. A central axis of the roller head 609 is rotatably supported by a bearing 611, and the bearing 611 is secured to a bearing attachment plate 613, and the bearing attachment plate 613 is attached to the pole 605. The bearing attachment plate 613 is elevatably attached to the pole 605, and thus, the roller head 609 is capable of elevating on the mold 619. Therefore, when replacing the mold 619 and the workpiece substrate 660, the replacing works can be facilitated by raising the roller head 609.

The bearing attachment plate 613 is elevated by a driving force applied by an electric motor 614. The electric motor 614 also generates a pressing force for the roller head 609 to press the mold 619. Generally, the electric motor has a feature that enables fine pressure control, but it is hard to generate a large force. Therefore, at least under the present conditions, it is difficult to use an electric motor in a simultaneous imprinting system, and in particular, if a large area (but still as small as approximately 10 cm×10 cm) is simultaneously transferred, it is very hard for the electric motor to do so. However, since the roller head 609 is used for the nanoimprint apparatus 600, an area that is pressed all at once becomes small, and thus, large pressure can be generated even by a small driving force. Therefore, the nanoimprint apparatus 600 can allow a small-sized electric motor that is capable of fine pressure control, to be used for applying pressure.

The central axis of the roller head 609 is connected to a pulley 615, and the pulley 615 is hung with a timing belt 617 for conveying the power of the motor that is installed under the base plate 601. When this motor power is conveyed to the roller head 609 via the timing belt 617 and the pulley 615, the roller head 609 can be rotated on the mold 619 in accordance with the motion of the stage 602. Therefore, the mold 619 and the workpiece substrate 660 are configured so as to be capable of being moved smoothly by the stage 602 even under the conditions where they are pressed by the roller head 609.

The workpiece substrate 660 (refer to FIG. 11) is held/secured by a vacuum chuck created by a porous adsorption hot plate 637 and 639. The porous adsorption hot plate 637 and 639 is also embedded with a heater for heating the workpiece substrate 660 up to the temperature necessary for pattern transfer. The porous adsorption hot plate 637 and 639 is secured by the stage 602 via a heat insulating material 635.

The device for holding the mold 619 comprises poles 621 and 629, a stepping motor 623, pullers 625 and 627, a spring hook 628, linear bearings 631 and 633, etc. These mold 619 holding devices are prepared in two sets as shown in FIG. 9 and FIG. 10, and they respectively secure the ends of the mold 619 to hold the mold 619. The pullers 625 and 627 are elevatably attached to the pole 621 by a driving force caused by the stepping motor 623. The puller 627 is penetrated by the pole 621 at the opposite side of the pole 621 and supported by the linear bearings 631 and 633 that are also penetrated by the pole 621. Such a configuration enables the puller 627 to maintain a horizontal position while being elevated by the stepping motor 623. The device for elevating the mold is also prepared in two sets as shown in FIG. 9, and it can be independently controlled. In other words, only one side can be elevated, and actually, this one side of the mold elevator is controlled during the implementation of the nanoimprint so as to be gradually elevated in conjunction with the motion of the stage 602, as will be described later with reference to FIG. 11.

FIG. 10 depicts an enlarged view of the main section of the securing structure for the mold 619 in the nanoimprint apparatus 600. As shown in FIG. 10, the mold 619 is secured so that both ends thereof are sandwiched with securing jigs 651. The mold securing jigs 651 are respectively provided with five pores 653, and the pores are respectively hung with one end of springs 657. The other end of the springs 657 are respectively hung on pores 655 located in the spring hook 628 that is jointed to the puller 627. In this way, the mold 619 is connected to the mold elevator via the mold securing jigs 651 and the springs 657. The varied force applied at the time of mold releasing can be absorbed with the elastic force of the springs by providing the springs 657. As shown in FIG. 10, the springs are easily removable because they are merely hung on the pores 653 and 655. Thus, springs having different constants can be used by replacing them, depending on the mold, molded body, and transfer pattern. Additionally, as shown in FIG. 10, a plurality of pores for hanging springs are provided for changing the number of springs in order to adjust the elastic force depending on the mold, molded body, and transfer pattern.

Referring to FIG. 11, the operation of the nanoimprint apparatus 600 will be described below. FIG. 11 (a) depicts the procedure immediately after operation of the nanoimprint has started. In FIG. 11, the structures provided with the same codes as FIG. 9 and FIG. 10 are the same structures as shown in FIG. 9 and FIG. 10, but it should be noted that they are more simplified than the structures shown in FIG. 9 and FIG. 10. Additionally, for the purpose of the explanations, the pole 621 and the puller 627 depicted on the left side of the figure are respectively described as 621a and 627a, and the pole 621 and the puller 627 depicted in the right side of the figure are respectively described as 621b and 627b, but theses are the same as the two sets of the pole 621 and the puller 627 depicted in FIG. 9 and FIG. 10, and have the same functions as them.

In FIG. 11 (a), the workpiece substrate 660 is secured by a vacuum chuck created by a porous adsorption hot plate 637 and 639, and the mold 619 is connected to the puller 627 via the springs 657. The stepping motor 623 lowers the position of the puller 627 so that the mold 619 and the workpiece substrate 660 are in contact with each other. The roller head 609 is also lowered by the electric motor 614 until contacting the mold 619, and furthermore, the mold 619 is pressed against the workpiece substrate 660 with the load F by the electric motor 614. The workpiece substrate 660 is heated up to a certain temperature, which is capable of transferring a pattern, by the heaters embedded in the roller head 609 as well as in the plate 637 and 639.

Once the head 609 starts pressing, the stage 602 is slowly moved in the left direction 671 of the figure. According to this motion, the part of the mold that is pressed by the head 609 is gradually moved. At this stage, the head 609 is also rotated in the direction 673 by the power conveyed via the pulley 615 and the timing belt 617, in conjunction with the motion of the stage 602, and thereby, the mold 619 and the workpiece 660 can be moved smoothly. The moving speed of the stage 602 should be controlled by the speed at which the pattern transfer may be sufficiently performed for the part that is pressed by the head 609.

FIG. 11 (b) depicts a procedure under the nanoimprint process. The puller 627a of the pullers 627, which is positioned forwards in the moving direction of the stage 602, is controlled so as to be gradually elevated in conjunction with the motion of the stage 602. Thus, in accordance with the motion of the stage 602, the part of the mold 619 where the head 609 is demolded, is demolded from the workpiece substrate 660 immediately after the head 609 is demolded. Since the workpiece substrate 660 immediately after the head 609 is demolded, is still sufficiently hot and is not much affected by the heat contraction, mold release can be smoothly performed. Of course, it is necessary to adjust the elevating speed of the puller 627a so that the mold release is performed after the transferred pattern is cooled down to the temperature at which it is firmed on the workpiece substrate 660. According to the elevation of the puller 627a, the mold 619 will be bent between the puller 627a and the head 609, but it is possible that the mold 619 has sufficient flexibility by choosing the materials of the mold and making the thickness of the mold thinner. The force necessary for mold release is slightly varied for the parts of the workpiece substrate 660 depending on the pattern structure to be transferred, but the springs 657 act to absorb this varied force.

FIG. 11 (c) depicts the procedure at a time when the nanoimprint operation has further progressed. It can be seen that the parts of the mold 619 which have been completed with the press are sequentially demolded from the workpiece substrate 660 by elevating the puller 627a according to the motion of the stage 602.

FIG. 11 (d) depicts the procedure at the time of completion of the nanoimprint operation. Once all necessary parts of the workpiece substrate 660 have been performed with the press, an electromagnetic motor 614 lifts the head 609 as well as the puller 627b, and thus, the mold 619 is completely demolded from the workpiece substrate 660.

The nanoimprint apparatus 600 may be controlled so as to firstly perform pressing on the entire workpiece substrate 660 by moving the stage 602 in the direction 671 without performing mold release, and subsequently to perform pressing from the direction opposite to FIG. 11 (a)-(d) by moving the stage 602 in the direction opposite to the direction 671 to perform mold release from the mold 619. The pattern can be transferred more clearly by performing a press from both sides in this way, depending on the patterns to be transferred. In this case, a puller 627 to be elevated in conjunction with the stage 602 is to be a puller 627b. Accordingly, the puller 627a and the puller 627b are preferably arranged to be capable of independently controlling elevation.

With respect to a thermal nanoimprint, there has been a problem in that mold release is difficult because molded bodies stick to a mold due to heat contraction when mold release is performed after the molded body is cooled, and thus, mold release requires a large force. There has also been a problem in that the transferred pattern is broken at the time of mold releasing by forcibly releasing the mold from the molded body. The larger the nanoimprint area is, the more pronounced these problems are. However, the nanoimprint apparatus 600 can perform mold release while the molded body is sufficiently hot and not much affected by heat contraction, thus allowing not only mold release to be performed smoothly but also prevent the problem of the pattern being broken at the time of mold releasing as much as possible.

FIG. 12 shows a control flow diagram of the nanoimprint apparatus 600. The operation control of the nanoimprint apparatus is performed by the controller 690. The controller 690 performs these controls by connecting to a stepping motor 603 for driving a stage 602, stepping motors 623a and 623b for two mold elevators, an electric motor 614 for elevating/pressing a roller head 609, a heater 609a installed in the roller head 609, a vacuum absorption machine 637a for a porous adsorption hot plate 637 and 639, and a heater 637b installed in the hotplate. The controller 690 may be provided inside or outside the nanoimprint apparatus 600, and control the equipment to be controlled by the operation of embedded CPU and software. The controller 690 preferably optimizes parameters for the relative moving speed between the mold and the object to be molded, the pressing load, and the temperature of the heater by sufficiently recognizing the viscoelastic properties and molding form for the resin of the workpiece material. The molding time can be significantly reduced by optimizing these parameters.

FIG. 13 shows a nanoimprint apparatus 700 for performing nanoimprinting on a long workpiece substrate, which is a variation of the nanoimprint apparatus 600. The nanoimprint apparatus 700 has a larger base plate 601′ than the base plate 601 of the nanoimprint apparatus 600, and differs from the nanoimprint apparatus 600 in that guide rollers 710a, 710b, 710c, and 710d for holding the long workpiece substrate 702 are installed on the base plate 601′. The guide rollers 710a-d are capable of not only holding the workpiece substrate 702, but also feeding the workpiece substrate 702 by sandwiching and rotating the workpiece substrate 702. Even for the case in which the workpiece substrate 702 is longer than the nanoimprint apparatus 700, this can be performed with a nanoimprint mold by performing nanoimprinting on the parts that can be molded all at once and then sequentially feeding the part of the workpiece substrate 702 to be molded for next time.

In the nanoimprint apparatus 700, the same codes are provided with the same components as the nanoimprint apparatus 600, the explanation of which is omitted.

The operation of the nanoimprint apparatus 700 will be described below with reference to FIG. 13. FIG. 13 (a) is the preparatory stage of the nanoimprint operation. The long workpiece substrate 702 is held by the guide rollers 710a-d and also absorbed by a vacuum chuck on the porous adsorption hot plate 637. The mold 619 is also secured to the mold elevator. In FIG. 13 (b), the mold 619 is lowered onto the workpiece substrate 702 via the puller 627a and 627b, and additionally, the roller head 609 is set on the mold 619 by the force applied by the electric motor 614. FIG. 13 (c)-(f) shows the procedure during nanoimprinting, in which the roller head 609 presses the mold 619 against the workpiece substrate 702 by the force applied by the electric motor 614 in the same way as the nanoimprint apparatus 600, while the mold and workpiece substrate 702 are concurrently moved by the stage 602 in the left direction of the figure, and additionally, the puller 627a is elevated in accordance with the motion of the stage 602, and the portion of mold 619 that have been completed with the press by the roller head 609 are immediately released from the workpiece substrate 702. The nanoimprint apparatus 700 differs from the nanoimprint apparatus 600 in that, in the steps shown in FIGS. 13(c)-(f), the guide rollers 710a-d are also rotated in accordance with the motion of the stage 602, which results in the position between the workpiece substrate 702 and the mold being kept in the correct position. Once the range that can be molded at one time has been completed with the nanoimprint by moving the stage from a start point to an end point, the roller head 609 and the puller 627b are elevated as shown in FIG. 13 (f), and the mold 619 is completely released from the workpiece substrate 702.

Subsequently, in FIG. 13 (g), the mold and the workpiece substrate 702 are returned to the position of FIG. 13 (a) by moving the stage 602 in the right direction of the figure. If necessary, the vacuum chuck of the porous adsorption hot plate 637 is stopped and the securing of the workpiece substrate 702 is demolded, while the guide rollers 710a-d are concurrently rotated to feed the workpiece substrate 702 in the left direction of the figure, and thus, the part to be molded next on the workpiece substrate 702 is transferred onto the porous adsorption hot plate 637. In FIG. 13 (h), the part to be molded next is set on the porous adsorption hot plate 637, and then returned to the condition of FIG. 13 (a). By repeating FIG. 13 (a) to (h), even a long workpiece substrate can be performed on with a nanoimprinting mold.

As described above, the preferred embodiments of the present invention have been described with examples, but it should be understood that the embodiments of the present invention are not limited to the above examples, and various embodiments are possible without departing from the scope of the present invention. For example, a mold and a workpiece substrate are moved relative to a head in the above examples, but an embodiment is also possible in which the head is slid relative to the mold and workpiece substrate. Additionally, a nanoimprint apparatus according to the above examples performs a pattern transfer by putting the mold on a superior surface of the workpiece substrate, but an embodiment is also possible in which a pattern transfer is performed by setting the mold under the inferior surface of the object to be molded or in which a pattern transfer is performed simultaneously for both surfaces by setting the molds on superior and inferior surfaces of the object to be molded. Of course, various numerical values used for the examples are provided by way of example only, and do not limit the present invention.

### BRIEF DESCRIPTION OF THE DRAWINGS

FIG. 1 is a conceptual diagram explaining the procedure of the thermal nanoimprint process.

FIG. 2 is a conceptual diagram of a nanoimprint apparatus 100 according to the present invention.

FIG. 3 is a diagram explaining the operation of a nanoimprint apparatus 100.

FIG. 4 is a conceptual diagram showing another embodiment of a nanoimprint head.

FIG. 5 is a conceptual diagram showing still another embodiment of a nanoimprint head.

FIG. 6 is a conceptual diagram showing still another embodiment of a nanoimprint head.

FIG. 7 is a conceptual diagram showing still another embodiment of a nanoimprint head.

FIG. 8 is a diagram explaining the operation of a nanoimprint system using the nanoimprint head shown in FIG. 7.

FIG. 9 is an external view of a nanoimprint apparatus 600 according to another embodiment of the present invention.

FIG. 10 is an enlarged view of a mold securing structure in a nanoimprint apparatus 600.

FIG. 11 is a diagram explaining the operation of a nanoimprint apparatus 600.

FIG. 12 is a control flow diagram of a nanoimprint apparatus 600.

FIG. 13 is a diagram explaining a nanoimprint apparatus 700 according to another embodiment of the present invention.

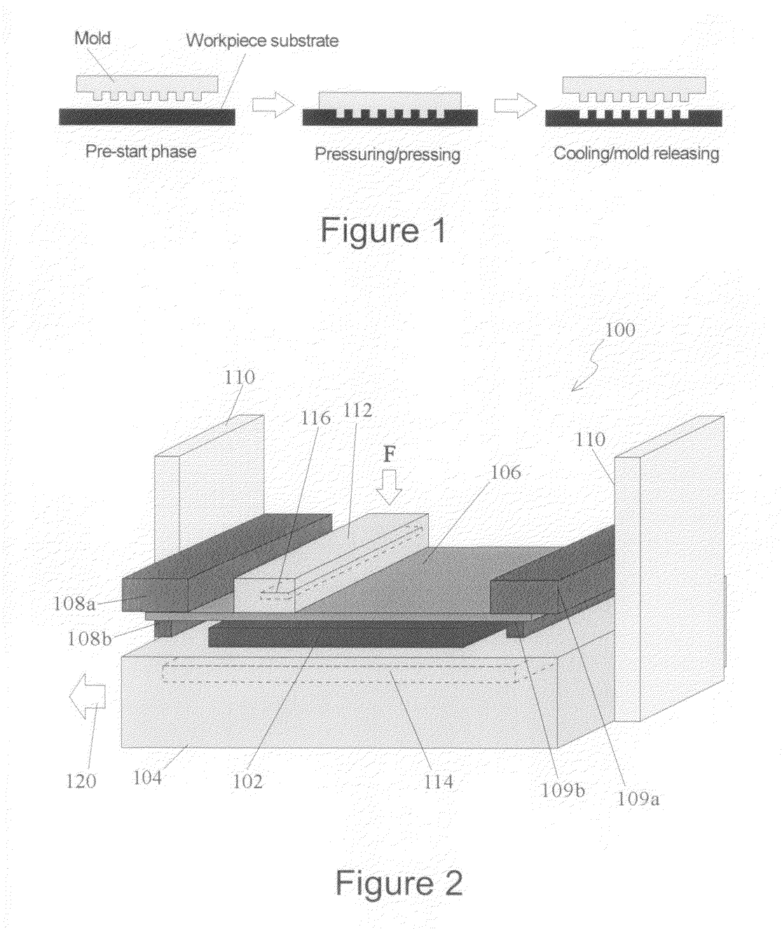

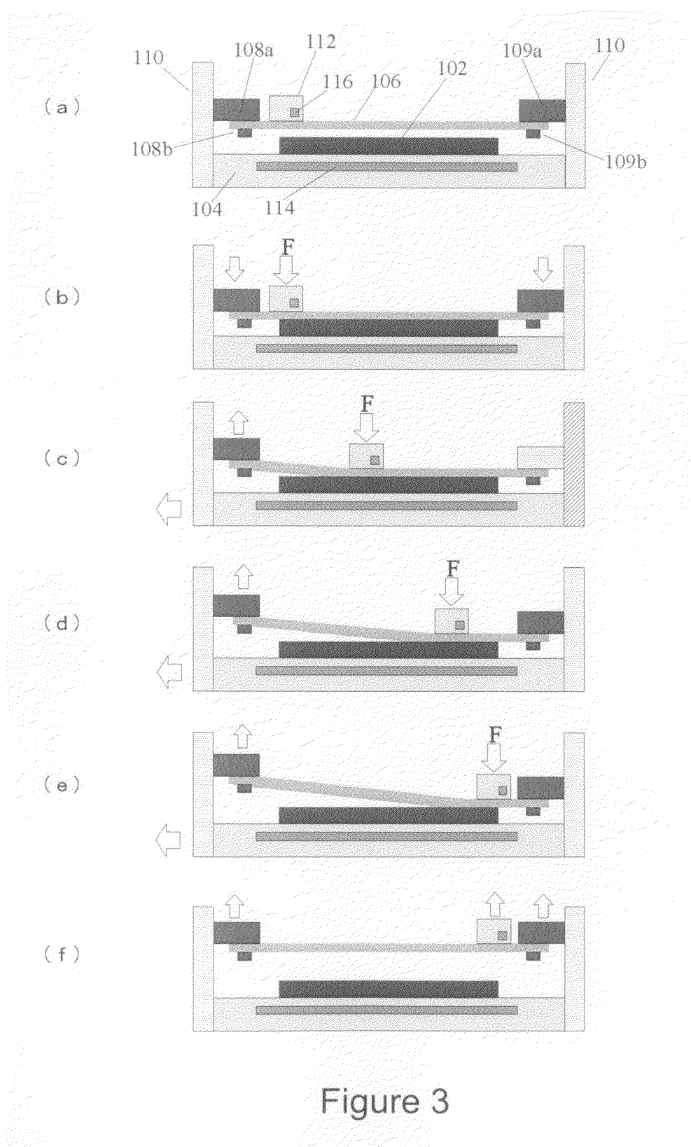

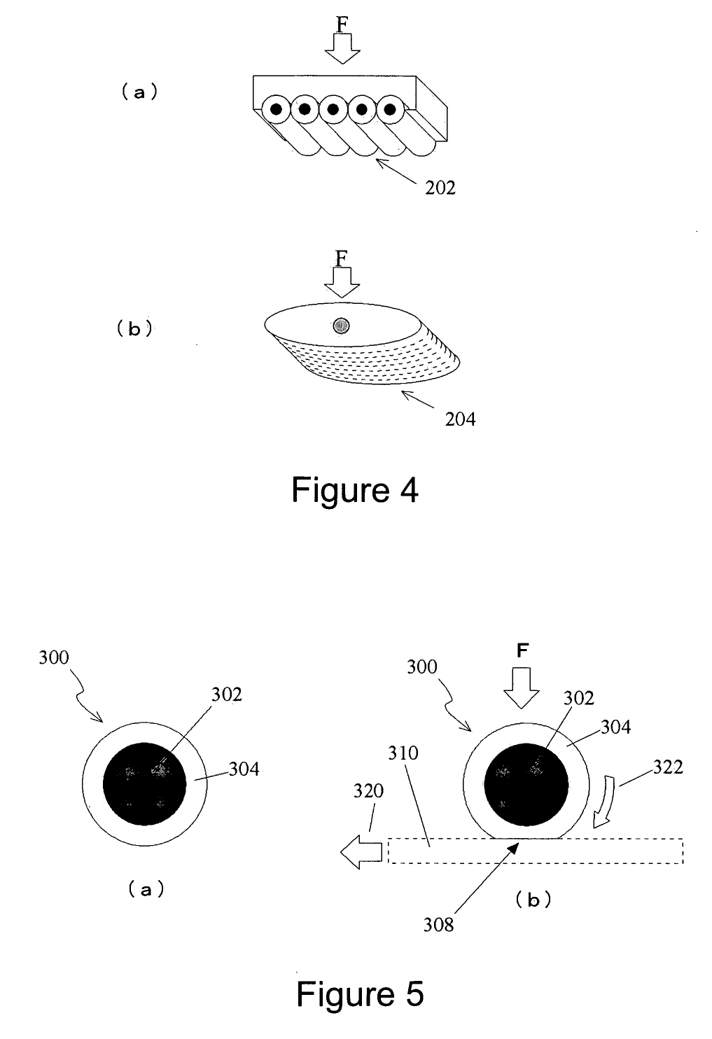

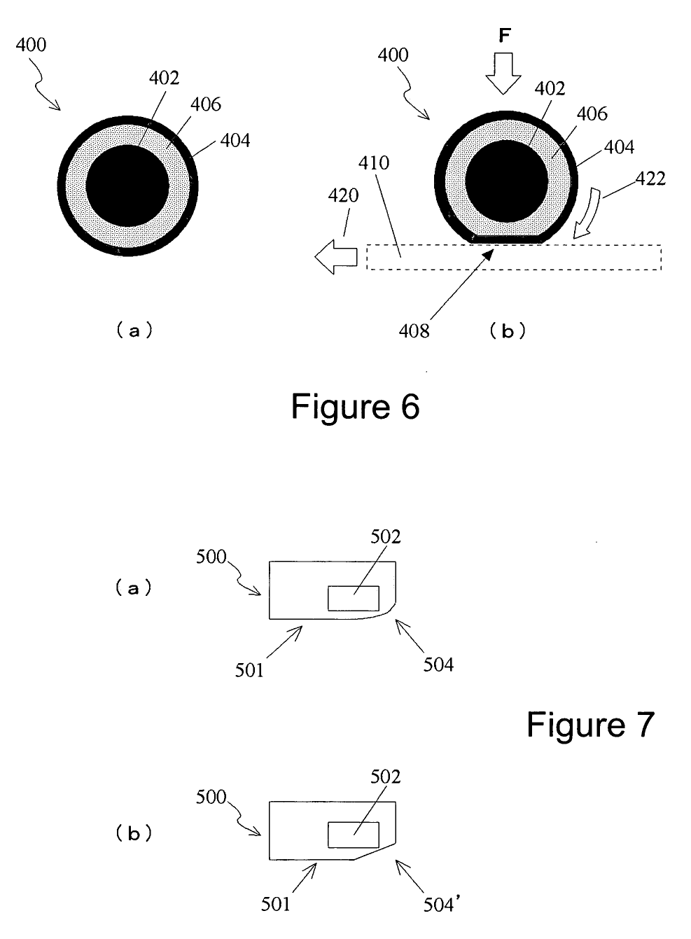

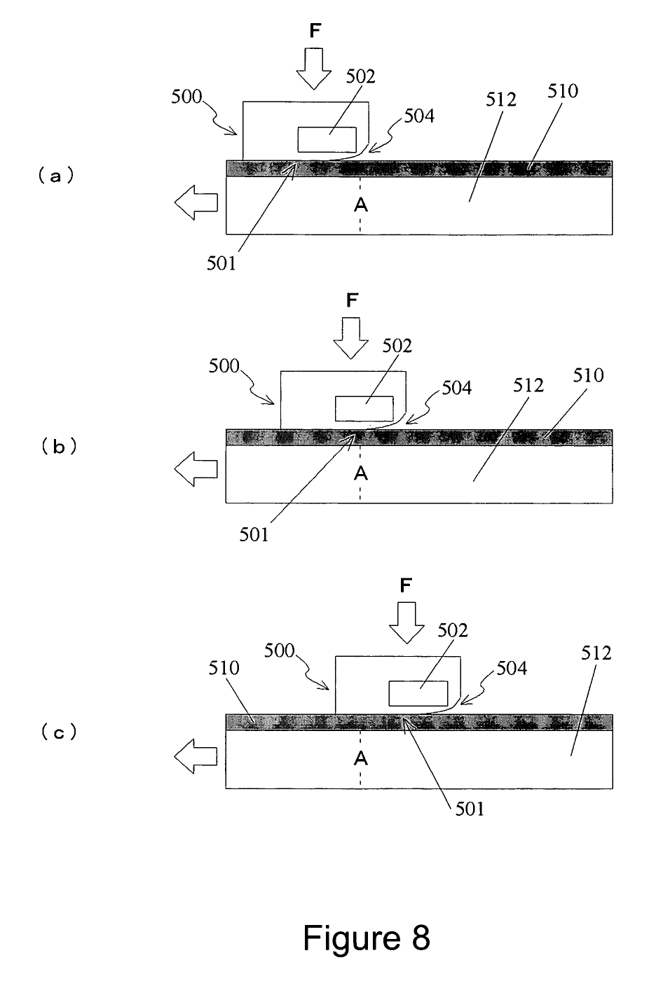

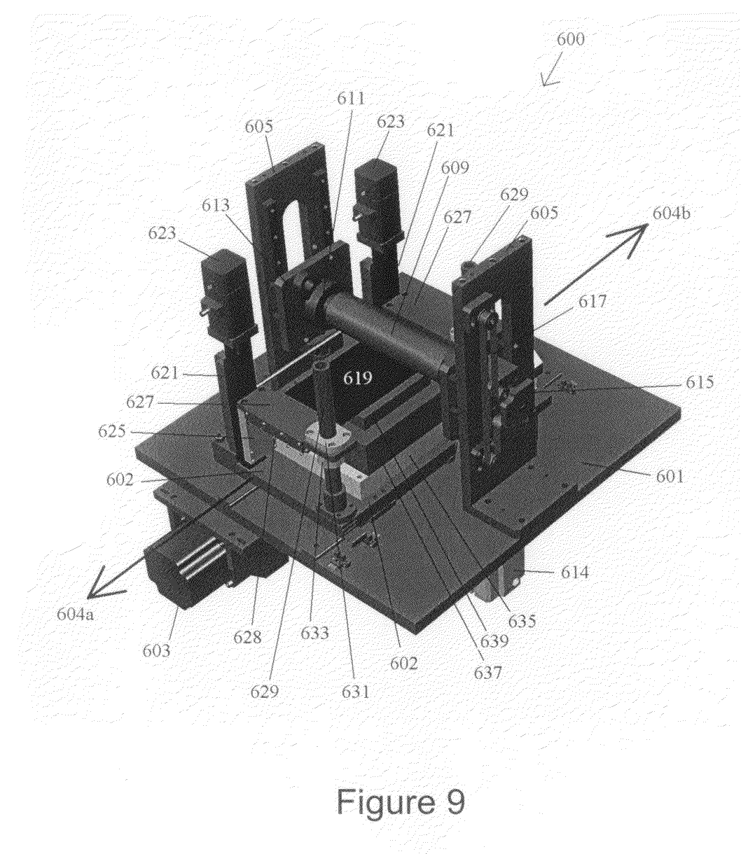

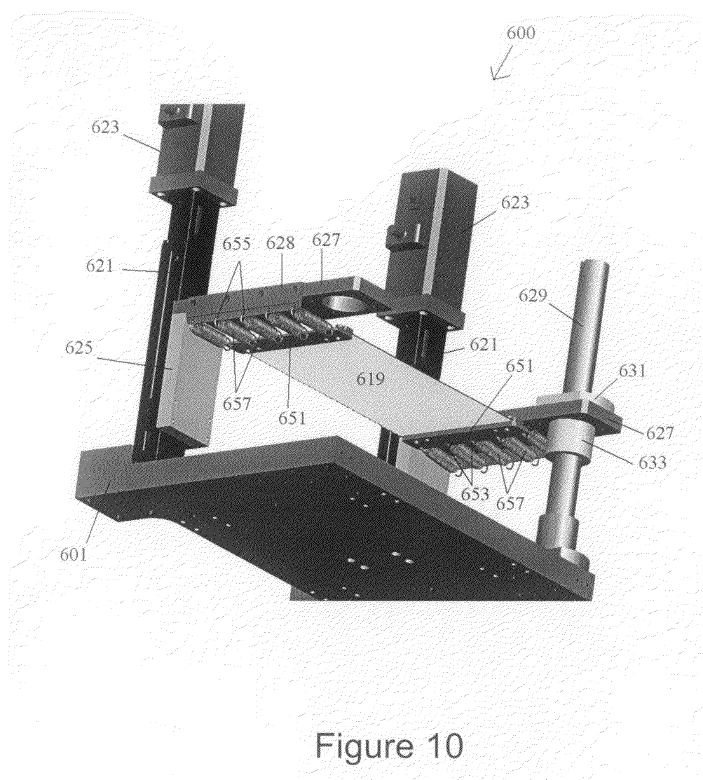

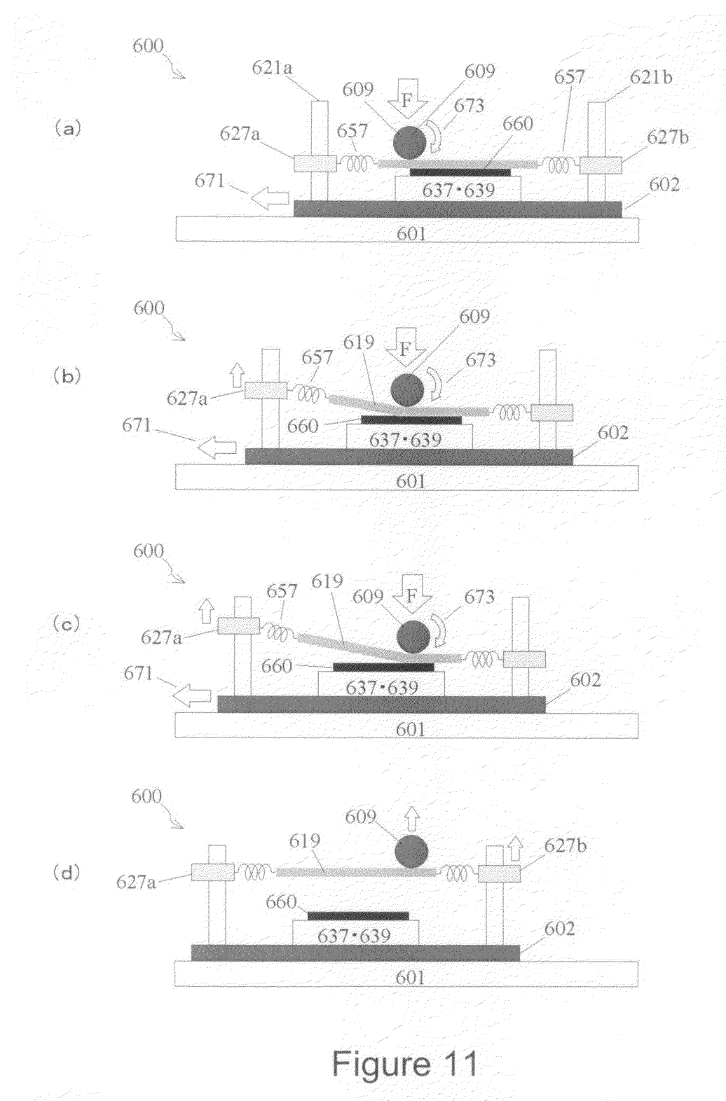

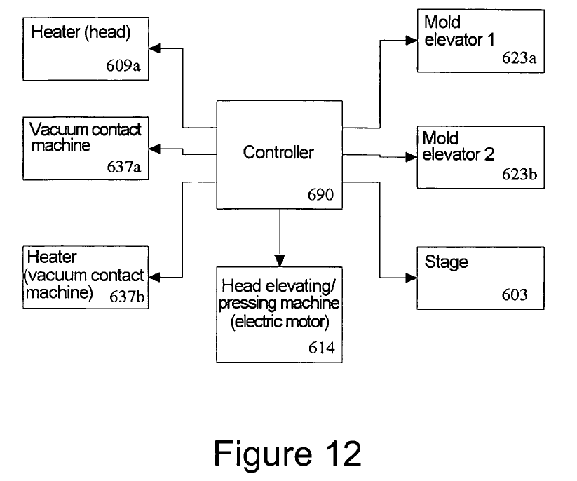

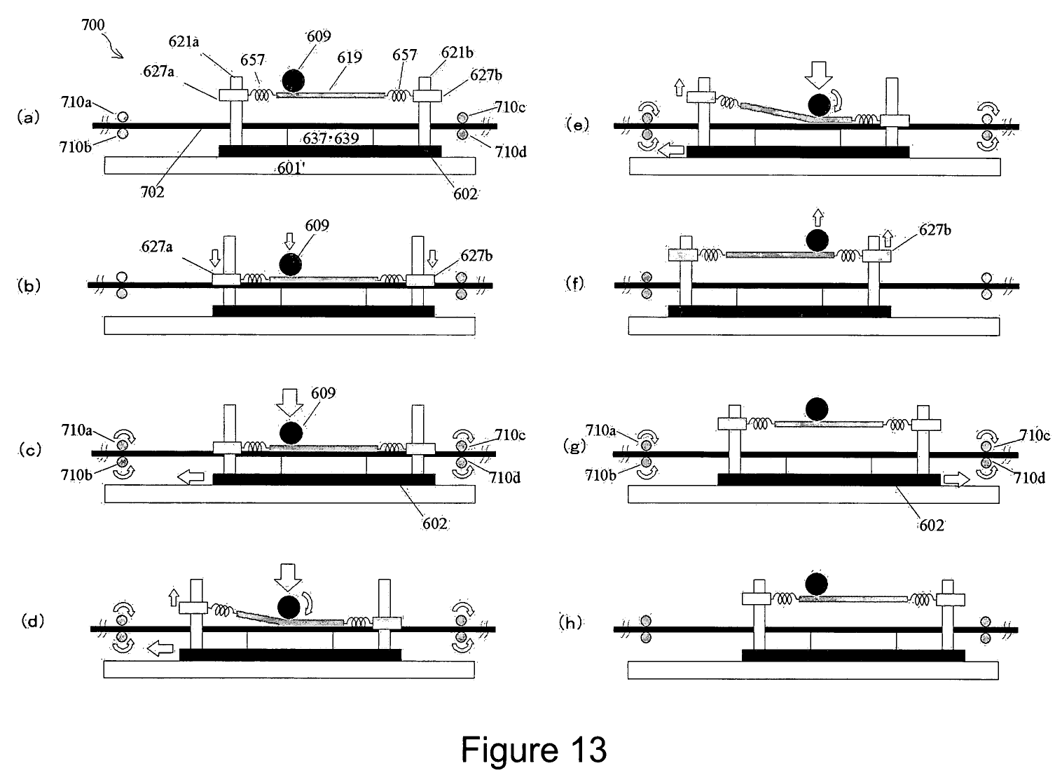

### DESCRIPTION OF THE SYMBOLS IN THE DRAWINGS

100 Nanoimprint apparatus
102 Workpiece substrate
104 Stage
106 Mold
108a, 108b Mold holding unit
110 Mold elevating mechanism
112 Head
114 Heater
116 Heater
600 Nanoimprint apparatus
601 Base plate
603 Stepping motor
605 Pillar for a roller head
609 Roller head
613 Bearing attachment plate
614 Electric motor
615 Pulley
617 Timing belt
619 Mold
621 Pillar
623 Stepping motor
627 Puller
629 Pillar
651 Mold securing jig
655 Pore
657 Spring
660 Molded product

1. A nanoimprint system for performing a pattern transfer onto an object to be molded by pressing a mold against the object to be molded using a head, where the head has a substantially flat pressing surface during pressing the mold and is arranged to press the mold while being slid onto the mold.

2. A nanoimprint system according to claim 1, where the head is slid onto the mold by configuring so that the mold is moved relative to the head.

3. A nanoimprint system according to claim 1, where the head is slid onto the mold by configuring so that the head is moved relative to the mold.

4. A nanoimprint system according to claim 1, where an effective width of the head is substantially the same as a width of the pattern transfer.

5. A nanoimprint system according to claim 1, where a part of the mold at which the pattern transfer has been completed is sequentially demolded while the head is continuously slid.

6. A nanoimprint system according to claim 1, arranged to apply fine vibration to the mold at the time of releasing the mold from the object to be molded.

7. A nanoimprint system according to claim 1, arranged that a relative speed between the head and the mold is variable depending on a position of the mold.

8. A nanoimprint system according to claim 1, arranged that the pressing force of the head is variable depending on a position of the mold.

9. A nanoimprint system according to claim 1, where a heater is installed within the head in a position biased to relative sliding direction of the head.

10. A nanoimprint system according to claim 1, where a relaxation part for relieving a pressing force applied to the object to be molded is provided at the edge of the pressing surface of the head in the sliding direction.

11. A nanoimprint system according to claim 10, where the relaxation part is formed by making the pressing surface curved in a direction away from the contact surface between the pressing surface and the mold.

12. A nanoimprint system according to claim 1, where the pressing surface is formed substantially flat by lining up a plurality of rollers on the pressing surface of the head.

13. A nanoimprint system according to claim 1, where the head comprises an endless track structure for facilitating sliding and a track shoe of the endless track structure forms the pressing surface.

14. A nanoimprint system according to claim 1, where the head comprises a cylindrical metal core and a surface layer made of rubber-like substances.

15. A nanoimprint system according to claim 1, where the head comprises a cylindrical metal core and a surface layer, as well as a structure filled with liquid between the core and the surface layer.

16. A nanoimprint system according to claim 15, where the surface layer is made of a thin metallic foil.

17. A nanoimprint method for performing a pattern transfer on an object to be molded by pressing a mold against the object to be molded using a head, the method including pressing the mold by a head while the head being slid on to the mold, where the head having a substantially flat pressing surface during pressing the mold.

18. A nanoimprint system for transferring a fine pattern formed on a mold onto an object to be molded by pressing the mold onto the object to be molded by using a pressing head, where said system carrying out a nanoimprint for an entire area to be molded by performing the press by using a head having a smaller pressing area than the entire area to be molded and by gradually changing positions to be pressed, where said system further comprising:
a jig for securing the area to be molded of the object to be molded,
a mold elevator arranged to secure the mold at one side and the other side thereof by a mold securing member, and to be capable of independently elevating the one side and the other side of the mold,
a stage for moving said jig for securing the object to be molded and the mold elevator relative to the head during nanoimprinting, and
a controller for controlling elevation of the mold elevator and motion of the stage, where the mold elevator and the stage are controlled to lift or lower one of the one side and the other side of the mold in accordance with the motion of the stage in order to release a part of the mold at which the press of the head has been finished from the object to be molded, during the nanoimprinting.

19. A nanoimprint system according to claim 18, arranged to variably control a moving speed of the stage during nanoimprinting.

20. A nanoimprint system according to claim 18, arranged that a pressing force applied by the head is controlled by the controller, and the controller is capable of variably controlling the pressing force in accordance with a motion of the stage.

21. A nanoimprint system according to claim 18, arranged that a heater, temperature of which is controlled by the controller, is provided with one or more of the head, said jig for securing the object to be molded, and the stage, where the controller is arranged to control the temperature of the heater in accordance with the motion of the stage.

22. A nanoimprint system according to claim 18, where a pressing surface of the head is of substantially a linear or elongated form.

23. A nanoimprint system according to claim 18, where a pressing force of the head is generated by an electric motor.

24. A nanoimprint system according to claim 18, where the head is a roller-type head which is rollably supported on the mold.

25. A nanoimprint system according to claim 24, comprising a motor for rotating the roller-type head in conjunction with the motion of the stage.

26. A nanoimprint system according to claim 18, where the mold securing member comprises a mold securing jig for securing the mold, and an elastic member for connecting the mold securing jig to a body of the mold elevator.

27. A nanoimprint system according to claim 26, where the elastic member is removable.

28. A nanoimprint system according to claim 27, where a plurality of connection units for connecting the elastic members are respectively provided with the mold securing jig and a body of the mold elevator.

29. A nanoimprint system according to claim 18, further comprising a guide for holding said object to be molded for a case in which the object to be molded is larger than said jig for securing the object to be molded, and capable of moving said object to be molded in accordance with the motion of the stage and independent of the motion of the stage.

30. A nanoimprint system according to claim 29, where the controller is arranged to feed, by the guide, next portion of the object to be molded onto said jig for securing the object to be molded after completing a nanoimprint of a portion currently secured to said jig for securing the object to be molded, then to secure said next portion to said jig for securing the object to be molded, and subsequently to perform a nanoimprint for said next portion.

31. A nanoimprint method for transferring a fine pattern formed on a mold onto an object to be molded by pressing the mold onto the object to be molded, comprising:
performing the press of the mold onto the object to be molded by using a head having a smaller pressing area than the mold,
gradually changing a part of the mold pressed by the head, and
releasing a part of the mold where the press by the head has been completed from the object to be molded in accordance with the change.

32. A nanoimprint method according to claim 31, where one or more of the changing speed, the pressing force, and the temperature of the heater is variably controlled.

33. A nanoimprint method according to claim 31, including completing a nanoimprint for a portion that can be molded by the mold at one time, then moving the object to be molded in order to align to the mold a next portion to be molded of the object to be molded, and then performing a nanoimprint for said next portion to be molded.

34. A nanoimprint system for transferring a fine pattern formed on a mold onto an object to be molded by pressing the mold onto the object to be molded, where the system is arranged to perform the press of the mold onto the object to be molded by using a head having a smaller pressing area than an area to be molded, while changing a part of the mold pressed by the head gradually, and to release a part of the mold in which the press of the head has been finished from the object to be molded in accordance with the change.
